(19) United States
(12) Patent Application Publication
(10) Pub. No.: US 2017/0129053 A1
(43) Pub. Date: May 11, 2017

(54) HOLDING DEVICE FOR A SUBSTRATE AND METHOD FOR COATING A TOP SURFACE OF A SUBSTRATE

(71) Applicant: Rolls-Royce Deutschland Ltd & Co KG, Blankenfelde-Mahlow (DE)

(72) Inventors: Susanne SCHRUEFER, Zossen (DE); Frank BRUECKNER, Dresden (DE); Mirko RIEDE, Dresden (DE)

(21) Appl. No.: 15/343,953

(22) Filed: Nov. 4, 2016

(30) Foreign Application Priority Data
Nov. 10, 2015 (DE) 10 2015 222 141.5

(51) Int. Cl. B23K 26/342

(52) U.S. Cl. CPC B23K 26/342; B23K 2201/001

(57) ABSTRACT

A holding device for a substrate during the performance of a generative laser method for applying a coating that comprises hard substance particles to a top surface of the substrate is provided. The wall of the substrate is completely surrounded by a thermoconductive wall of the holding device at least in the area of the top side. The wall of the holding device protrudes beyond the top side with a projection that is at least in the size range of the thickness of the coating and the wall of the holding device is arranged perpendicular to the top side, so that a laser-induced molten coating bath can be supported by means of the wall of the holding device, and the coating has the shape of the substrate in the horizontal cross-section.

### REFERENCE TO RELATED APPLICATION

This application claims priority to German Patent Application No. 10 2015 222 141.5 filed on Nov. 10, 2015, the entirety of which is incorporated by reference herein.

### BACKGROUND

The invention relates to a holding device for a substrate and a method for coating a top surface of a substrate.

It is known that phase transformations may occur when a substrate coating with hard substance particles is applied by means of a generative laser method, which leads to instabilities. Another challenge is to maintain a desired geometry of the coating.

What is known from EP 0 349 501 A1 is a device that describes a generative laser method for applying a coating.

### SUMMARY

The present invention is based on the objective to provide an improved holding device and an improved method for coating a top surface of a substrate.

According to the invention, this objective is achieved by the arrangement with the features as described herein.

The holding device serves for receiving a substrate during the performance of a generative laser method for applying a hard substance particle coating to the top side of the substrate. Here, the wall of the substrate is completely surrounded by a thermoconductive wall of the holding device at least in the area of the top side of the substrate. For example, the wall of the substrate can be completely enclosed by the holding device.

At that, the wall of the holding device protrudes beyond the top side of the substrate with a projection, which is at least in the size range of the coating thickness to be applied. The circumferential projection can serve for providing a certain degree of stability to the coating during manufacture, in particular in the liquid or in the malleable state. In particular the wall of the holding device is arranged so as to be perpendicular to the top side of the substrate.

Thus, a laser-induced molten coating bath can be supported on the top side of the substrate through this arrangement of the wall of the holding device. In the horizontal cross-section, the coating has the shape of the substrate.

Since the wall of the holding device comprises a thermoconductive wall, a targeted temperature control, for example a targeted cooling, can be achieved during the application of the coating.

Thus, the holding device can serve for giving the coating a desired geometrical shape and at the same time for reducing the risk of a phase transformation (for example the formation of undesired phases) by targeted heat dissipation.

In one embodiment, the substrate can be spatially fixated by means of the wall of the holding device.

In one embodiment, the projection can have half to three times the size of the thickness of the coating to be applied.

In another embodiment variant, the holding device is adjusted to the substrate in such a precisely fitting manner that the distance between the wall of the holding device and the substrate is less than 0.2 mm in the area of the top side.

In one embodiment form, the wall of the holding device in particular comprises a material with a low weldability with respect to the used substrate material. In this manner, it can for example be avoided that the holding device is connected to the substrate while being heated by a laser. Such a material can for example be copper, aluminum, brass, bronze, or ceramic materials.

In another embodiment variant, the holding device, in particular the wall, comprises a material that has a high reflectance for laser light. In a generative laser method, the used laser light is thus reflected in all the places where the material of the holding device is present. However, it is not reflected particularly at the top side of the substrate, and can thus unfold its effect in a targeted manner in order to create a molten coating bath. Here, too, for example copper, brass or bronze can be used. At that, the material is to be selected with respect to the reflectance of the wavelength of the laser. Particularly copper has a high reflectivity with the typically used wavelengths, while the substrate absorbs the laser power well in this area.

Alternatively or additionally, it is also possible that the wall of the holding device comprises a material with a high thermal conductivity, in particular copper or aluminum. In this manner, an effective temperature control of the substrate can be achieved.

In order to improve the cooling of the substrate, in one embodiment the wall of the holding device can have an active cooling device for adjusting a temperature of the wall of the holding device—and thus also of the substrate. At that, for example the temperature of the wall of the holding device can be adjusted with a control device for the cooling device. Here, one possibility is that the cooling device is configured as a liquid cooling, in particular as a water cooling. Water has a high thermal capacity, so that it is well suited as a cooling agent. Principally, evaporative cooling by means of water or liquefied gases (for example nitrogen) is also possible.

In this manner, it is in particular possible to control the temperature of the wall of the holding device from room temperature up to several hundred degrees Celsius.

In one embodiment, the substrate is a structural component of a turbomachine, in particular a blade or a seal element.

This objective is achieved through a method as described herein.

At that, the method comprises the following steps:

a) providing the substrate;
b) masking the substrate with a holding device according to at least one of the claims 1 to 12;
c) creating a molten coating bath by means of laser deposition welding on the top side of the substrate;
d) implanting hard substance particles into the molten coating bath and/or the top side of the substrate by means of laser deposition welding, wherein the created molten coating bath is supported by the wall of the holding device, and the heat of the molten coating bath is at least partially dissipated by the holding device.

### BRIEF DESCRIPTION OF THE DRAWINGS

In the following, the invention is explained based on exemplary embodiments in connection to the figures.

FIG. 1 shows a perspective and schematic rendering of a first exemplary embodiment of a holding device that completely encloses a substrate.

FIG. 2 shows the holding device of FIG. 1A in a cross-section perpendicular to the longitudinal direction and through the center point of the holding device.

FIG. 3 shows the holding device of FIG. 1A in a cross-section perpendicular to the transverse direction through the center point of the holding device.

FIG. 4 shows the holding device of FIG. 1A from above, in a plane perpendicular to the vertical direction of the holding device.

FIG. 5 shows a perspective rendering of a second exemplary embodiment of a holding device, with a cooling device and a control device, that completely encloses a substrate.

FIG. 6 shows a perspective rendering of a third exemplary embodiment of a holding device, comprised of two elements.

FIG. 7 shows the holding device of FIG. 5 that encloses a substrate, and a coating device for coating by means of a generative laser method.

FIGS. 8A to 8C shows three successive states during coating of a surface of the substrate by means of a generative laser method.

FIG. 9 shows an enlarged rendering of the coating that comprises a metal bath and implanted hard substance particles.

FIG. 10 shows, in a perspective manner, a rotor blade after a coating has been applied.

FIG. 11 shows a sectional view of the rotor blade in a holding device.

### DETAILED DESCRIPTION

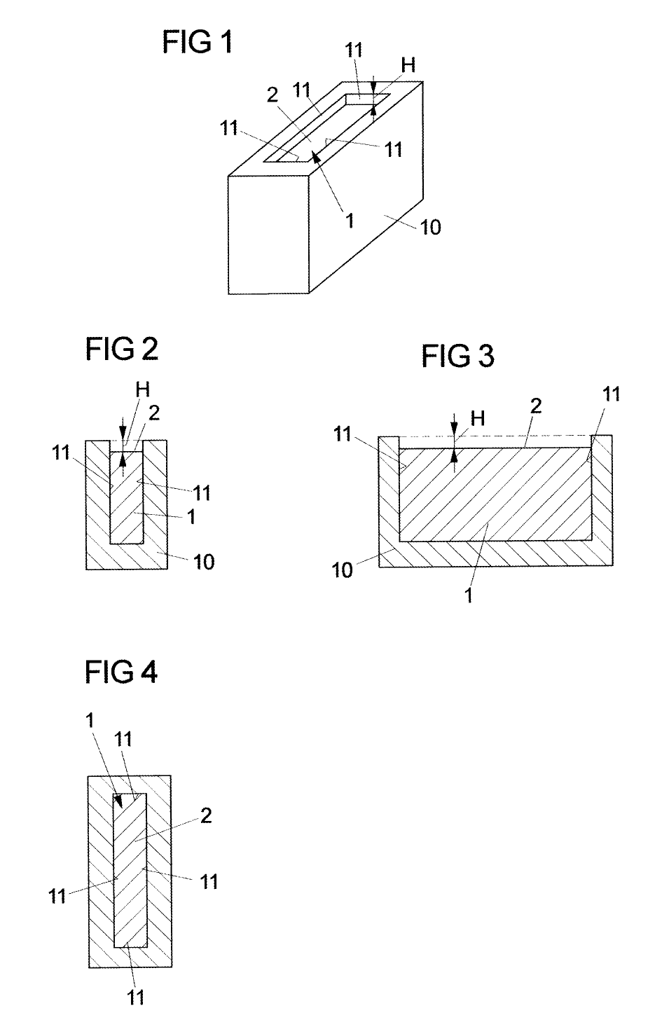

FIG. 1 shows a first embodiment variant of a holding device 10 for a substrate 1 in a perspective manner. A coating is to be applied to a top side 2 of the substrate 1.

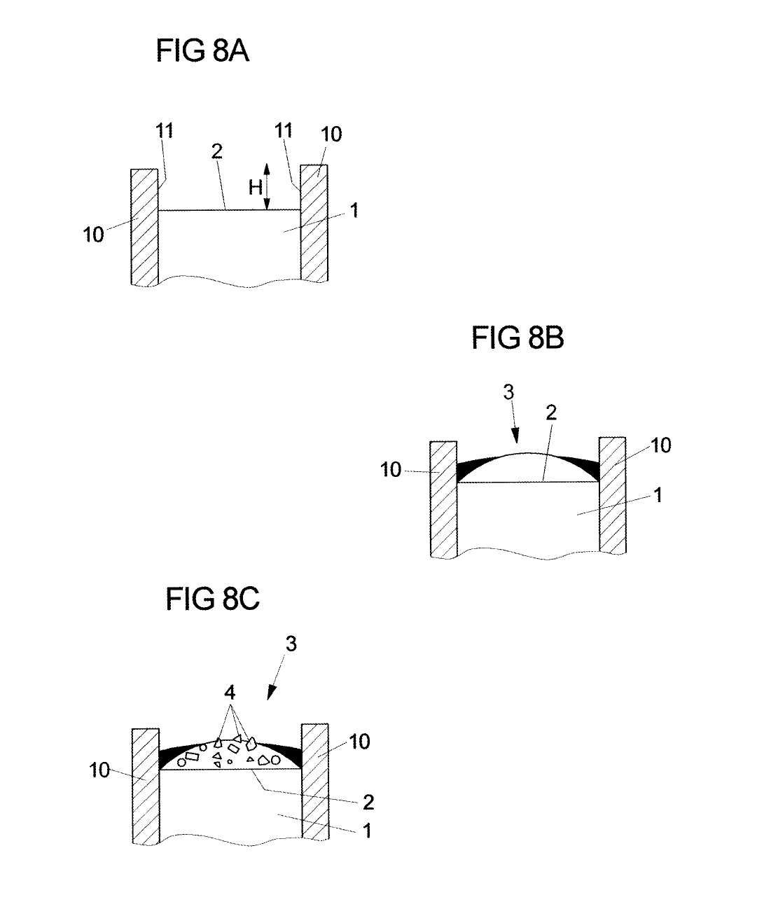

The holding device 10 encloses the substrate 1 on four sides, while a coating 3 (see FIGS. 8A, 8B, 8C, for example) is applied to the top side 2 of the substrate 1 by means of a generative laser method (for example a DLD method). Here, the coating 3 comprises hard substance particles 4.

In this embodiment variant, the holding device 10 is configured in one piece and has a cuboid-shaped outer contour. Further, the holding device 10 has a cuboid-shaped indentation that serves for receiving the substrate 1.

The cuboid-shaped indentation is delimitated on four sides (that is, completely) by a thermoconductive wall 11 of the holding device 10, i.e the wall 11 of the holding device 10 is oriented towards the substrate 1 during operation. The substrate 1 has an extension that is only minimally smaller than the extension of the indentation. In the present case, the distance between the substrate 1 and the wall 11 of the holding device 10 is less than 0.2 mm.

In alternative embodiments, the holding device 10 and also the substrate 1 can have a different shape. Thus, the horizontal cross-section of the substrate 1 can for example have a square, polyhedral or also a complex shape. However, in any case the walls 11 of the holding device 10 surround the substrate 1 on all sides.

FIG. 2 shows a cross-section perpendicular to the longitudinal direction of the holding device 10 according to FIG. 1. FIG. 3 shows a cross-section perpendicular to the transverse direction. FIG. 4 shows the holding device 10 according to FIG. 1 from above, in a plane perpendicular to the vertical direction of the holding device 10.

As can be seen in FIGS. 1 to 4, the wall 11 of the holding device 10 protrudes beyond the top side 2 of the substrate 1 by the projection H. The top side 1 is oriented so as to be substantially perpendicular to the wall 11 of the holding device 10.

The substrate 1 is thus lowered in the vertical direction. The projection H is in the size range of the coating 3 to be applied. In some embodiment variants, the projection H can have half to three times the size of the thickness of the coating 3 to be applied. In this size range of the projection H, it is possible to support the molten coating at its sides.

The wall 11 can spatially fixate the substrate 1, in particular during the coating of the substrate 1.

In some embodiment variants, the wall 11 of the holding device 10 can comprise a material with at least one of the following characteristics: a low welding tendency, a high reflectance for laser light, or a high thermal conductivity. This material can particularly be copper.

FIG. 5 shows a variant of the embodiment according to FIGS. 1 to 4, so that the above description may be referred to. Here, the holding device 10 additionally has an active cooling device 12, with the active cooling device 12 surrounding the wall of the holding device 10 from outside. The cooling device 12 is controlled by means of a control device 13.

In alternative embodiments, the cooling device 12 can also be integrated inside the wall 11 of the holding device 10. It is also possible that the cooling device 12 is arranged only in certain parts of the holding device 10.

The cooling device 12 can be a liquid cooling, in particular a water cooling, as in the embodiment variant that is shown here. By means of the cooling device 12, that is for example controlled by a control device 13, a temperature of the wall 11 of the holding device 10 can be adjusted. For example, the wall 11 of the holding device 10 can be temperature-controlled to room temperature.

Apart from the temperature, the temperature profile can also be adjusted by means of the control device 13, so that a targeted cooling is possible.

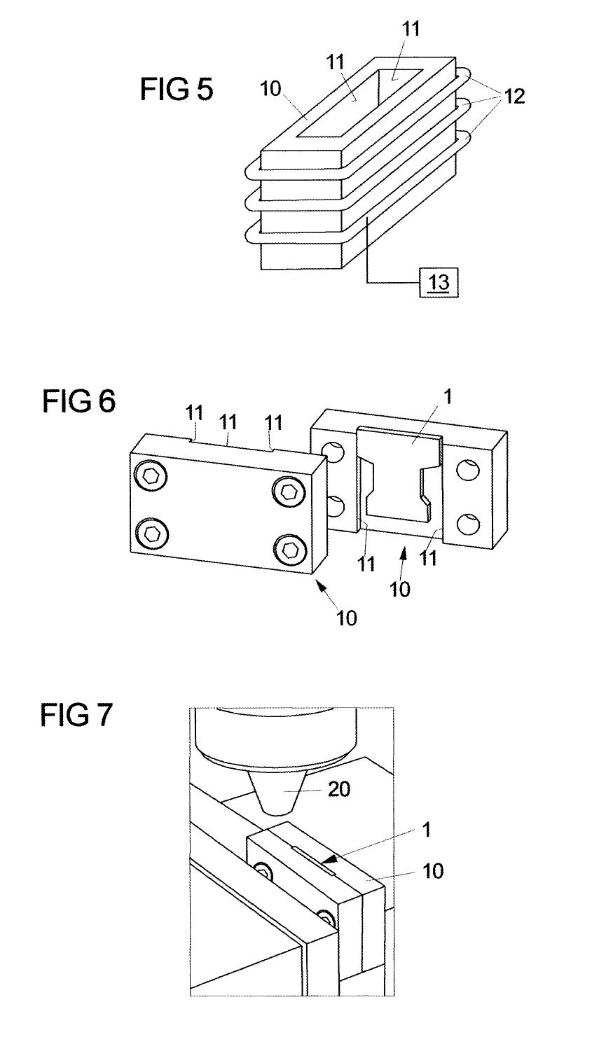

In a further embodiment variant, which is shown in FIG. 6, the holding device 10 is comprised of two halves that can be connected to each other, which in the present case is carried out by means of screwed connections. In this manner, the reception at the substrate 1 inside an indentation of the holding device 10 is facilitated. The substrate 1 can be clamped between the two mirror-symmetric halves of the holding device 10.

FIG. 7 shows the holding device 10 of FIG. 6, so that the above description may be referred to. Here, a device 20 is additionally shown that serves for coating the surface 2 of the substrate 1 by means of a generative laser method. At that, the coating device 20 comprises a laser as well as a powder supply means.

The laser serves for creating a molten coating bath at the surface 2 of the substrate 1. A first powder supply means serves for supplying a first powder, in particular MCrAlY, for creating the molten coating bath. The second supply means serves for supplying hard substance particles 4, in particular cBN particles.

In connection to FIGS. 8A to 8C it is shown how the coating of the surface 2 of the substrate 1 is carried out in one embodiment. In all three Figures, the holding device 10 according to FIG. 1, comprising the enclosed substrate 1, is shown in sections in a cross-section perpendicular to the longitudinal direction.

In a method for coating a top surface 2 of a substrate 1, at first the substrate 1 has to be provided. Next, the substrate 1 is masked with a holding device 10. This situation is shown in FIG. 8A.

Subsequently, a molten coating bath is created on the top side 2 of the substrate 1 by means of laser deposition welding, that is, by using a laser while a first powder is being supplied. The laser serves for the localized fuzing, at first of the top side 2 of the substrate 1. Into this molten bath, the powder is introduced. This powder, too, is molten by the laser, wherein further powder is supplied. The result of this is shown in FIG. 8B.

In a subsequent step, the hard substance particles 4 are implanted into the molten coating bath and/or into the top side 2 of the substrate 1 by means of laser deposition welding. At that, the greater part of the hard substance particles 4 is not molten. The hardened molten coating bath forms the coating 3 of the top side 2 of the substrate 1. This is shown in FIG. 8C.

The holding device 10 supports the created molten coating bath through the projection H of the wall 11, so that the coating 3 has the shape of the substrate in the cross-section perpendicular to the vertical direction, that is, in the horizontal cross-section.

The heat of the molten coating bath is dissipated at least partially through the holding device 10.

In embodiment variants of the holding device 10 that comprise an active cooling device 12, the temperature of the holding device 10 can be adjusted in a targeted manner. This can be used for controlling the heat dissipation in a targeted manner.

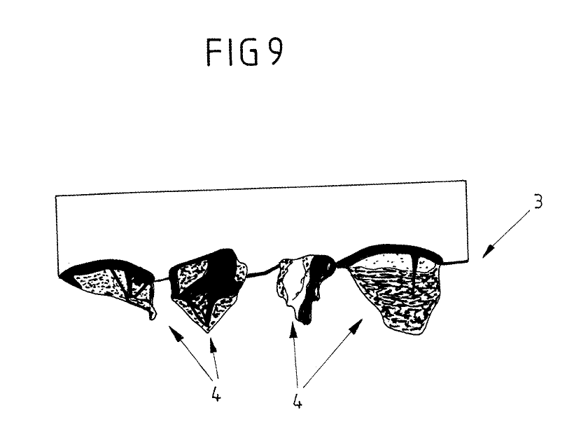

As is shown in FIG. 9, a coating 3 that is manufactured in this manner and that comprises a metal bath and hard substance particles 4 implanted therein, has no glassy phase. The hard substance particles 4 are directly connected to the metal bath.

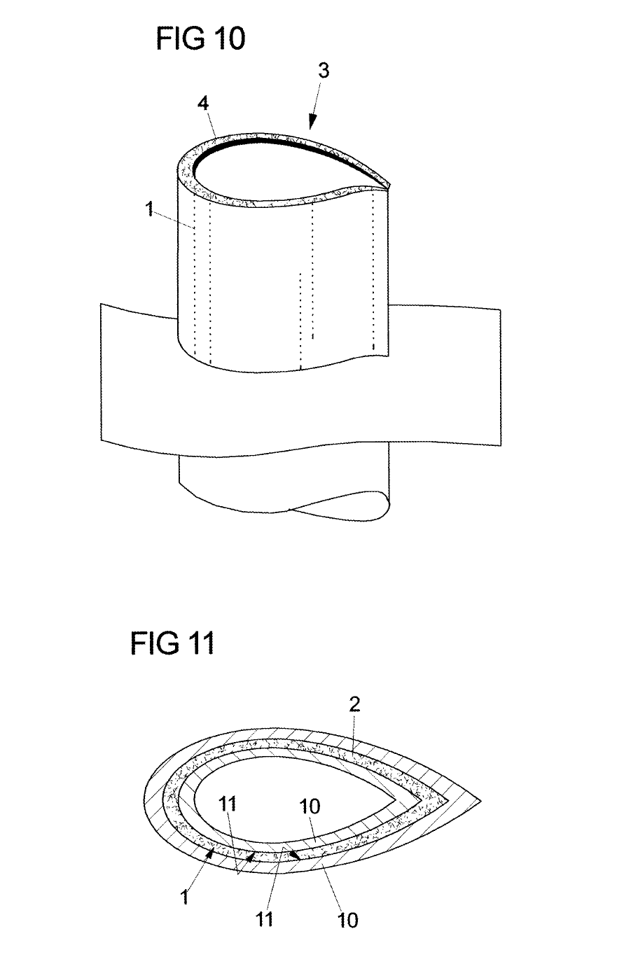

FIG. 10 shows a rotor blade 1 of a turbomachine in a perspective view, after a coating 3 has been applied to the top surface 2 of the rotor blade 1, the rotor tip. The shape of a rotor blade is complex, as the cross-section changes at every height, for example. A holding device 10 for such a complexely shaped part has walls 11 that are correspondingly shaped. The main goal here is to apply coating to the blade tips.

This arrangement is shown in FIG. 11 from above, in a sectional plane perpendicular to the vertical axis or the radial axis of the rotor blade 2.

In this cross-section, the rotor blade 2 has a contour that is comprised of a wall and encloses a hollow space. The inner as well as the outer wall of the rotor blade 2 are respectively surrounded by a wall 11 of the holding device 10 at least in the area of the surface 2, that is, in the area of the rotor blade.

Thus, the holding device 10 is comprised of two parts also in this embodiment variant. Both parts are respectively shaped so as to be contoured correspondingly to the rotor blade. One part fits exactly into the inside of the rotor blade, and one part fits exactly around the outer circumference of the rotor blade.

In further embodiment variants that are not shown here, the holding device 10 can thus be adjusted to further contours of a top side 2 of a substrate 1 to be coated.

### PARTS LIST

1 substrate (rotor blade)
2 top side
3 coating
4 hard substance particle
10 holding device
11 wall of the holding device
12 cooling device
13 control device
20 coating device
H projection

1. A holding device for a substrate during the performance of a generative laser method for applying a coating that comprises hard substance particles to a top surface of the substrate, wherein
the wall of the substrate is completely surrounded by a thermoconductive wall of the holding device at least in the area of the top side,
the wall of the holding device protrudes beyond the top side with a projection that is at least in the size range of the thickness of the coating, and
the wall of the holding device is arranged perpendicular to the top side, so that a laser-induced molten coating bath can be supported by means of the wall of the holding device, and the coating has the shape of the substrate in the horizontal cross-section.

2. The holding device according to claim 1, wherein the substrate can be spatially fixated by means of the wall of the holding device, in particular during the coating of the substrate.

3. The holding device according to claim 1, wherein the projection is half to three times as high as the thickness of the coating.

4. The holding device according to claim 1, wherein the distance between the substrate and the wall of the holding device is less than 0.2 mm in the area of the top side.

5. The holding device according to claim 1, wherein in particular the wall of the holding device comprises a material with a low welding tendency, in particular copper.

6. The holding device according to claim 1, wherein in particular the wall of the holding device comprises a material with a high reflectance for laser light, in particular copper.

7. The holding device according to claim 1, wherein in particular the wall of the holding device comprises a material with a high thermal conductivity, in particular copper.

8. The holding device according to claim 1, wherein the wall of the holding device comprises an active cooling device for adjusting a temperature of the wall of the holding device.

9. The holding device according to claim 8, wherein the temperature of the wall of the holding device can be adjusted by means of a control device for the cooling device.

10. The holding device according to claim 8, wherein the cooling device is configured as a liquid cooling, in particular as a water cooling.

11. The holding device according to claim 1, wherein the wall of the holding device can be temperature-controlled to room temperature.

12. The holding device according to claim 1, wherein the substrate is a structural component of a turbomachine, in particular a blade or a seal element.

13. A method for coating a top surface of a substrate, in particular of a structural component of a turbomachine, comprising the following steps:
a) providing the substrate;
b) masking the substrate with a holding device according to claim 1;
c) generating a metal bath by means of laser deposition welding on the top side of the substrate;
d) implanting hard substance particles into the metal bath and/or the top side of the substrate by means of laser deposition welding, wherein the molten coating bath that is thus created is supported by means of the wall of the holding device, and the heat of the molten coating bath is at least partially dissipated through the holding device.
